(19) United States
(12) Patent Application Publication
(10) Pub. No.: US 2005/0278079 A1
(43) Pub. Date: Dec. 15, 2005

(54) Apparatus and method for displaying graphical information relating to vehicle operation

(76) Inventor: Joel M. Maguire, Northville, MI (US)

Correspondence Address: CHRISTOPHER DEVRIES;General Motors Corporation, Mail Code 482-C23-B21, P.O. Box 300, Detroit, MI, 48265-3000, US

(21) Appl. No.: 10/866,920

(22) Filed: Jun. 14, 2004

(51) Int. Cl. G06F 17/00

(52) U.S. Cl. 701/1; 340/425.5

(57) ABSTRACT

A method and an apparatus are provided for displaying operational information of an automobile on a signal processing device within an interior cabin of the automobile. The apparatus comprises a first automobile control module configured to generate a first output signal corresponding to the operational information of the automobile and an interface circuit configured to couple the signal processing unit and the first automobile control module. The first interface circuit has a signal translating circuit that is configured to convert the first output signal for use by the signal processing device in displaying the operational information of the automobile. The apparatus also comprises a holder associated with the interface circuit and configured to removably attach the signal processing device to the interior cabin space of the automobile.

### TECHNICAL FIELD

The present invention generally relates to an apparatus and a method for processing information provided by modules of a vehicle control system that are monitoring various events, and more particularly relates to displaying selected items of such information in graphical form to a driver or other user of the vehicle.

### BACKGROUND

Many kinds of mechanical equipment utilize electrical sensors or transducers to provide electrical output signals for measuring parameters and/or identifying physical events related to the operation and condition of vehicular systems. Such output signals can be processed and displayed on a screen viewable by the driver or other user of the vehicle. The amount of information capable of being displayed is increasing as motorized vehicles continue to evolve. For instance, the recently introduced Parallel Hybrid Vehicle (PHV) utilizes an Internal Combustion (IC) engine and/or an Electric Motor (EM) to provide power to the vehicle drive wheels. There are significantly more modes of operation inherent in this PHV than in an older conventional vehicle having only an IC engine. These PHV operating modes include IC engine only, EM only, combined IC and EM and regenerative electric braking, for instance. With the exception of the IC engine only mode, these are all new modes of operation to most vehicle operators. Moreover conventional power trains also either presently include or are planned to include new technologies such as variable valve timing, displacement on demand, and alternative transmission shifting schedules, for example.

Presently information from vehicle control modules are displayed on custom, purpose built monitor systems having screens that are permanently installed in vehicles. Graphical and textual images on such screens presently provide limited graphical user interfaces (GUIs) to vehicle operators and/or technicians. However, such prior art solutions tend to be undesirably inflexible, expensive and limited in the scope of the information presented. For instance, prior art purpose built GUIs do not have the flexibility to simultaneously serve as information providers, diagnostic tools and teaching tools. Also, prior art GUIs that are integrated into vehicle dashboards require significant investments in engineering time and piece part costs. Moreover, such prior art GUIs generally do not display fuel savings from the operations of the previously mentioned new PHV and IC engine technologies that are designed to be mostly transparent to the vehicle operators and passengers. Also, as mentioned, one such new IC engine technology involves cylinder displacement on demand, which changes the number of active cylinders of an IC engine in response to changes in engine loading. A vehicle operator or driver may be aware of driveline events associated with changes in the displacement on demand system or changes in the mode of operation of a PHV system, but not know what specific vehicle operations are causing them.

Some customers or drivers prefer technology to be transparent. These customers do not want to be aware of the inter-workings and operation of their vehicles. Instead such customers only want to enjoy the benefits of the technology and are likely to be annoyed by purpose built GUIs that are integrated into vehicle dashboards. Unfortunately, such displays cannot be easily removed from the vehicle and thus can take up space that might be utilized for other applications. Other drivers or customers however view the new technologies as an important feature and are interested in viewing the new functions and the operations thereof.

In view of the foregoing, it should be appreciated that it is desirable to provide an inexpensive method and an apparatus providing a GUI for displaying selected information from vehicle control modules in a new and meaningful way. It is also desirable for such GUIs to provide a teaching tool for vehicle sales people, drivers, potential customers and other vehicle users. Furthermore, it is desirable for the apparatus and method to facilitate the logging of diagnostic data related to vehicular technologies so that such data can be provided to original equipment manufacturers or technicians. Moreover, it is desirable that such methods and apparatus have either no changes or only minimal changes in the other portions of the overall vehicle system. In addition, it is desirable that signal processing devices and display screens providing such GUIs be easily removed by users who prefer the technology to be transparent from vehicles without impacting such vehicles. Furthermore, it is desirable that such method and apparatus utilize Commercial Of The Shelf (COTS) products that can be reprogrammed as the need arises. Such uses of COTS products decrease costs and provide flexibility. Additionally, it is desired that such apparatus utilize diagnostic ports that are either already installed or planned to be installed in the interiors of the cabins of modern automotive vehicles. Furthermore, other desirable features and characteristics of the present invention will become apparent from the subsequent brief summary, detailed description, appended claims, and abstract, taken in conjunction with the accompanying drawings and the foregoing technical field and background.

### BRIEF SUMMARY

A method is provided for displaying operational information of an automobile on a signal processing device within an interior cabin of the automobile. The apparatus comprises a first automobile control module configured to generate a first output signal corresponding to the operational information of the automobile and an interface circuit configured to couple the signal processing unit and the first automobile control module. The first interface circuit has a signal translating circuit that is configured to convert the first output signal for use by the signal processing device in displaying the operational information of the automobile. The apparatus also comprises a holder associated with the interface circuit and configured to removably attach the signal processing device to the interior cabin space of the automobile.

In addition to the apparatus, methods are provide for displaying operational information of an automobile on a signal processing device within an interior cabin of the automobile. The method comprises the steps of receiving output signals corresponding to the operational information of the automobile and modifying the output signals to provide modified output signals for use by the signal processing device in displaying the operational information of the automobile. The method also comprises the steps of selecting at least one of the modified output signals and displaying the operational information of the automobile corresponding to the at least one of the modified output signals on the signal processing device within the interior cabin of the automobile.

### BRIEF DESCRIPTION OF THE DRAWINGS

The present invention will hereinafter be described in conjunction with the appended drawing figures, wherein like reference numbers denote like elements, and

FIG. 1 shows a view of a Personal Digital Assistant (PDA) affixed to the dashboard of a motorized vehicle;

FIG. 2A shows a front view and FIG. 2B shows an end view of the PDA of FIG. 1 in a holder that enables the PDA to be easily removed from the dashboard;

FIG. 3 is a simplified general diagram of an automotive control system including the PDA of FIG. 1 and an interface device for the PDA of FIG. 1;

FIG. 4 is a block diagram of the interface device of FIG. 3;

FIG. 5 is a flow chart of a method of an exemplary embodiment of the invention;

FIGS. 6A, 6B, 6C and 6D show PDA screens with various displays; and

FIGS. 7A, 7B and 7C show PDA screen concepts related to vehicle fuel usage;

FIGS. 8A, 8B and 8C show various PDA screen concepts; and

FIGS. 9A, 9B and 9C show PDA screen concepts related to the modes of operation of a parallel hybrid vehicle.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

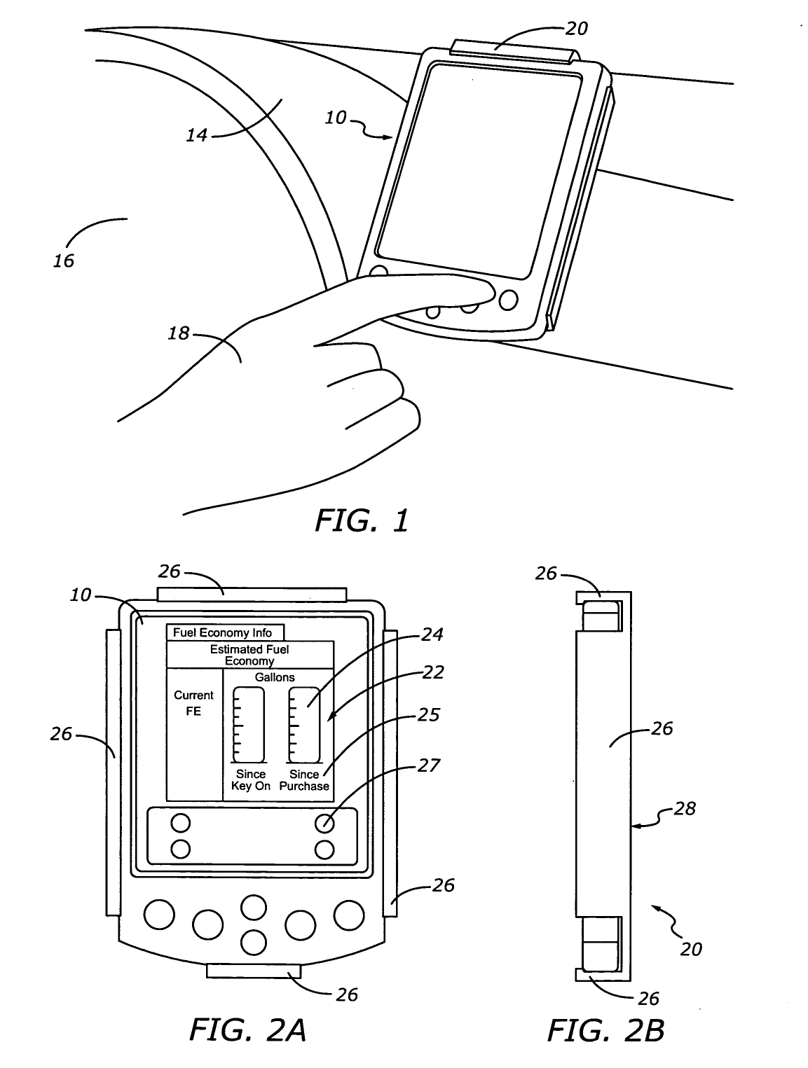

Referring to FIG. 1, a signal processing device or personal digital assistant (PDA) 10 is shown affixed to the dashboard 14 within the interior 16 of the cabin space of a motorized vehicle (not shown) and preferably within easy reach of the hand 18 of an operator. PDA 10 can be a COTS device such as a commonly available Palm Pilot, for instance. A holder or docking device 20 that can be similar to a cell phone holder enables PDA 10 to be easily removed from the vehicle if PDA 10 is not needed, thus freeing up the space otherwise taken by PDA 10.

FIG. 2 A shows a front view and FIG. 2B shows an end view of the PDA 10 and the holder or docking device 20. PDA 10 includes a screen 22 for displaying graphical information 24 and/or textual information 25. A user generally operates PDA 10 by using known controls such as a wiggle-stick, stylus, a finger actuated to pad, for example. (not shown) and/or buttons 27. Holder 20 preferably has top, bottom and side members 26 for gripping the case of the PDA 10. FIG. 2B shows the back surface 28 of holder 20.

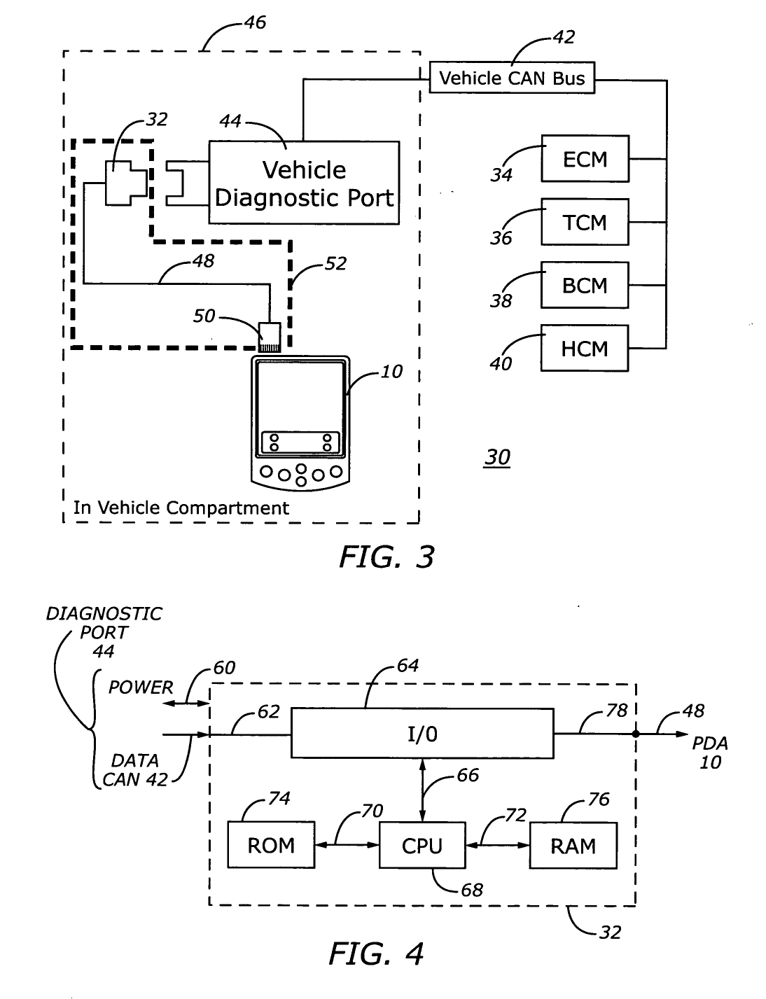

FIG. 3 is a simplified general diagram of an automotive control system 30 in which an exemplary embodiment of this invention is utilized and which includes an interface device 32 for PDA 10. In this illustrative example, system 30 includes an engine control module 34, a transmission control module 36 and a body control module 38 that are of known configurations. For PHV applications, a hybrid module 40 is also preferably included in the system 30. Each of these modules (34, 36, 38) or other modules include sensors providing output signals or data indicative of monitored events or parameters. A vehicle Controller Area Network (CAN) bus 42 electrically connects or conducts in a known manner the data from modules (34, 36, 38, 40) to a commonly used vehicle diagnostic port 44. Port 44 is located in the interior 16 of the cabin space for the vehicle driver as indicated by dashed block 46. A PDA interface 32 is arranged to plug into or mate with port 44. Cable 48 and connector 50 connect PDA interface 32 to PDA 10 as indicated by dashed block 52.

FIG. 4 shows a block diagram for the PDA interface and signal translating device 32 of FIG. 3. Diagnostic port 44 provides power on conductor 60 for the components of PDA interface 32. Also, port 44 provides data from CAN 42 through conductor 62 to an Input/Output (I/O) device 64. Two way conductor 66 interconnects I/O device 64 with a Central Processing Unit (CPU) 68 that may include one or more microprocessors or microcontrollers. Two-way conductors (70, 72) respectively interconnect CPU 68 with read only memory (ROM) 74 and random access memory (RAM) 76. Conductor 78 connects the output of I/O 64 to cable 48. In operation, PDA interface 32 translates the data from CAN 42 into serial data that can be processed by PDA 10. I/O 64 provides any necessary shifts in the levels of such data. In addition, ROM 74 provides temporary memory storage of such data. CPU 68 performs and controls logic operations under the directions of programs stored in RAM 76.

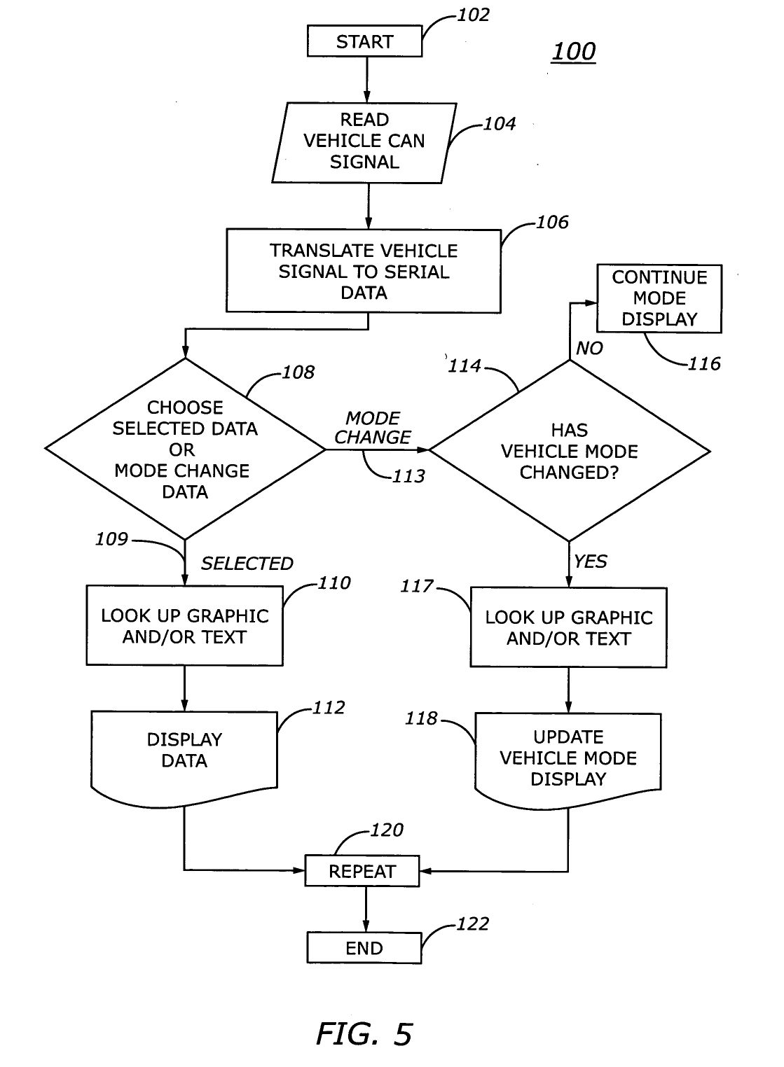

PDA 10 effectuates a GUI method 100 for displaying real-time data in the form of meaningful screens indicating vehicle operation. Method 100 is shown by the flow chart of FIG. 5 and provides another preferred exemplary embodiment of the present invention. The data is selected either by a user or selected automatically, such as for mode display data. The apparatuses (30, 32) respectively of FIG. 3 and FIG. 4 effectuate method 100. Specifically, the processor or processors 68 and memories (74, 76) in PDA interface block 32 of FIG. 4 are configured to cooperate with PDA 10 to perform the steps of method 100. The series of steps carried out in PDA interface 32 can be stored as a sequence of controller steps in ROM 76.

Generally, method 100 has either a user controlled or a vehicle mode controlled state of operation. More specifically, a processing cycle of method 100 of FIG. 5 begins with step 102 in response to an interrupt signal. This interrupt signal causes I/O module 64 of FIG. 4 to read the vehicle CAN signals per input step 104 and deliver corresponding signals to CPU 68. The CAN signals are then translated into serial data per function step 106 by interface 32.

In decision step 108 the user determines whether to view user selected data or vehicle determined data such as the mode changes of a hybrid vehicle, for instance. If user selected data as indicated by the method flow line 109 is chosen then the PDA 10 is directed to lookup a particular predetermined graphic and/or text per function step 110. Next, the graphic and/or text is displayed by PDA 10 per step 112. Alternatively, if hybrid mode change is selected as indicated by the method flow line 113, then decision step 114 determines whether the vehicle mode has changed. If the answer is No, then the present mode continues to be displayed per function step 116. On the other hand, if the mode has changed then the answer is Yes and function step 117 causes the appropriate graphic and/or text to be retrieved and displayed per step 118. PDA 10 continues to repeat per step 120 some or all of the above-described steps until a user shuts down PDA 10 per the “END” step 122.

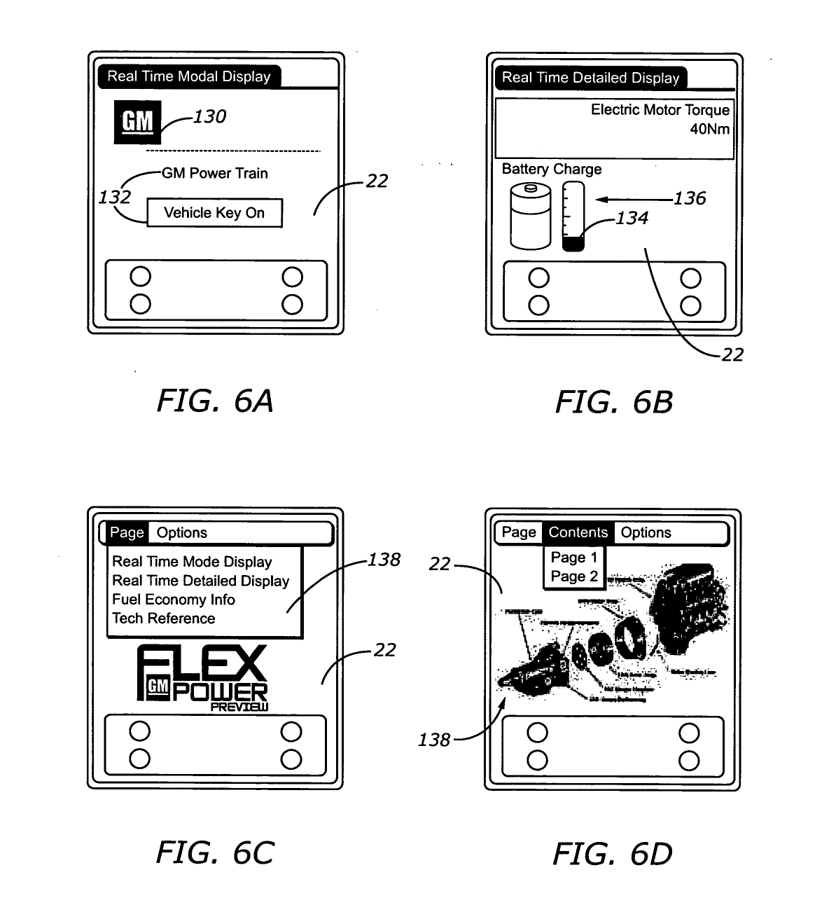

The following GUI Storyboard descriptions provide Screen Concepts in Column 1 for PDA 10 corresponding to the Hybrid Powertrain of Column 2 and Expected Actions for PDA 10 of Column 3. Storyboard 1 and FIGS. 6A, 6B, 6C and 6D depict a variety of screen concepts.

### Storyboard 1

| Column 1 | Column 2 | Column 3 |
|---|---|---|
| Screens | Hybrid Powertrain | Expected Action |
| shown by: | | |
| | Key On | Display GM Powered Logo |
| | | and a key state message. |
| | Battery State of Charge | Display an animated battery that |
| | | changes with state of charge |
| | Upon User Request | Display interactive introduction |
| | | to teaching tool for PHV. |
| | | Multiple pages. |

More specifically, referring to FIG. 4, FIG. 5 and FIG. 6A, upon the initial start up step 102 of method 100, CPU 68 is programmed to automatically provide signals through I/O 64, which cause PDA 10 to look up and display logo 130 and text 132 on the screen 22. This action corresponds to steps 110 and 112 of method 100. Next data is obtained from the HCM 40 of FIG. 3 relating to the state of EM battery charge and the level 134 of graphic 136 is adjusted by PDA 10 either automatically or upon user request per step 108 as shown in FIG. 6B. The user could then choose Tech Reference from the menu 138 shown in FIG. 6C to cause PDA 10 to look up and show the display related to a teaching tool for the PHV indicated by the text and graphical images 138 of FIG. 6C. In this case, multiple pages beginning with the page shown in FIG. 6D are displayed by PDA 10. The teaching tool provides insight to sales people, drivers and/or customers into the motivation and the workings of the new technology.

Storyboard 2 assumes the user has chosen to view Fuel Economy Info from menu 138 of FIG. 6C.

### Storyboard 2

| Column 1 | Column 2 | Column 3 |
|---|---|---|
| Screen Concepts | Hybrid Powertrain | Expected Action |
| shown by: | | |
| | Upon key off or user | Display message |
| | request | “Est. Fuel Economy Today” |
| | | Use BSFC/Odo formulas |
| | Upon user request | Display message |
| | | “Estimated Fuel Economy |
| | | Since Purchase” Store |
| | | these values |
| | Decel Fuel Cut off | Display message |
| | | “Fuel Saved By Decel Fuel |
| | | Cut Off” |

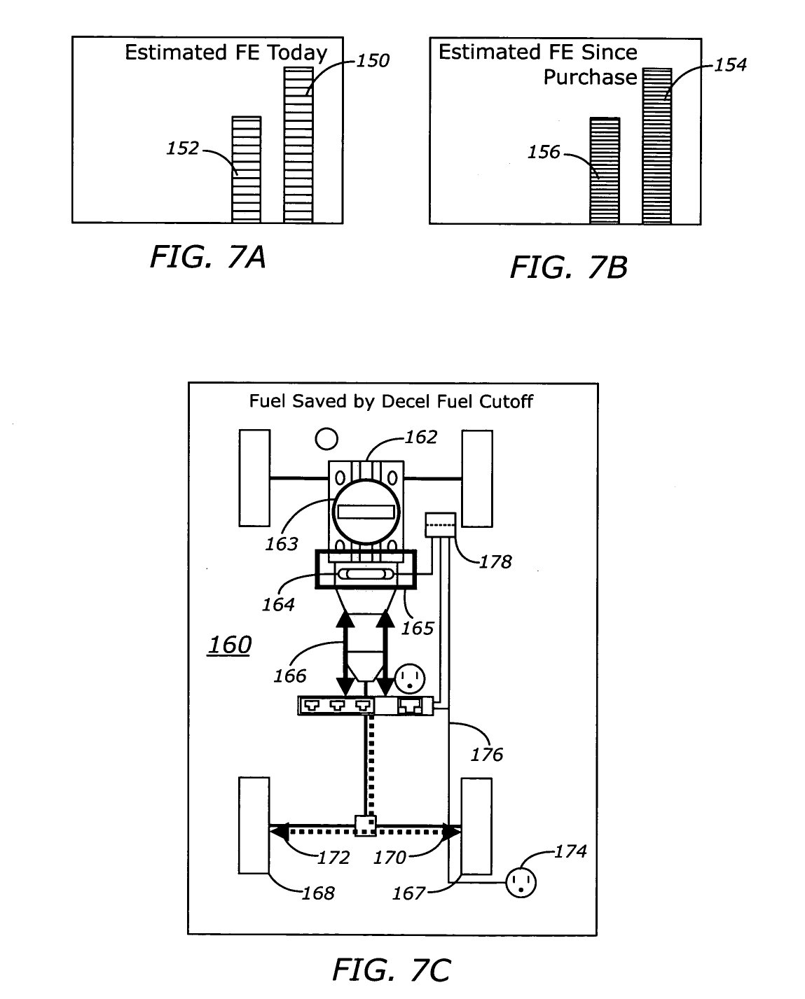

As used herein, BSFC refers to a Brake Specific Fuel Consumption signal and Odo refers to an odometer signal indicating how many miles the vehicle has traveled. Generally, when the driver or other user requests detailed real time selected data per method flow line 109 of FIG. 5, then calculations can be made within PDA 10 to turn the serial data from interface 32 into meaningful information and graphics. For instance, if Fuel Economy Info is selected from menu 138 of FIG. 6C by a user then the BSFC fuel rate from ECM 34 and the Odo signals from BCM 38 can be used to calculate either the amount of fuel saved or the Fuel Economy (FE) of a hybrid vehicle. These amounts can be respectively compared to the amount of fuel saved or to the fuel economy of a comparable traditional, non-hybrid vehicle. Specifically, FIG. 7A shows a bar graph 150 indicating Estimated Fuel Economy Today of the hybrid vehicle and another bar graph 152 indicating the FE of the traditional vehicle. Also, FIG. 7B shows a bar graph 154 indicating Estimated FE since purchase of the hybrid vehicle and another bar graph 156 indicating the estimated FE of the traditional vehicle.

FIG. 7C shows a graphic representation or ICON of the main functional parts of a parallel hybrid vehicle 160 having an engine 162 and an EM 164. The graphic of FIG. 7C indicates the hybrid vehicle is in a deceleration fuel cutoff mode (Decel Fuel Cut Off). The Decel Fuel Cut Off (DFCO) graphic of FIG. 7C occurs when ECM 34 has detected that that the driver has lifted his/her foot off of the accelerator and that the vehicle is coasting and/or decelerating so that the fuel to the IC engine 162 is cutoff thus saving additional fuel. Specifically, the circular graphic 163 on the IC engine 162 indicates that the IC engine is inoperative. The rectangular graphic 165 on the EM 164 indicates that the electric motor is operative and supplying power through the transmission 166 to the rear drive wheels (167, 168) as indicated by respective arrows (170, 172). Hence, the graphical representation of FIG. 7C indicates which of the main part of hybrid vehicle 160 are operational during the DFCO mode of operation. Power plug 174 is connected through vehicle power line 176 to storage battery 178. Plug 174 mates with the outlet of an appropriate source of electrical power (not shown) for charging battery 178.

The following Storyboard 3 occurs in response to the user selecting Real Time Detailed Display from PDA menu 138 of FIG. 6C. Selection of the real time display enables the driver to view selected details about the operation of the vehicle rather then just pop up images such as those displayed in response to selection of Real Time Mode Display from menu 138 corresponding to the powertrain modes. IEO refers to the off time of the IC engine and PT refers to powertrain.

### Storyboard 3

| Column 1 | Column 2 | Column 3 |
|---|---|---|
| Screen Concepts | Hybrid | Expected Action |
| shown by: | Powertrain | |
| | Upon key off | Display message: |
| | or user request | “unfueled engine” fuel savings |
| | | over traditional PT”, |
| | | Use cumulative IEO time X |
| | | traditional idle fuel rate = gallons |
| | Upon user | Display message |
| | request | “EM torque”, |
| | | Give some indication of hybrid |
| | | operation and events |
| | Torque | Display message |
| | Smoothing | “Fuel Saved by Fuel Cutoff”, for |
| | | IEO or DFCO |

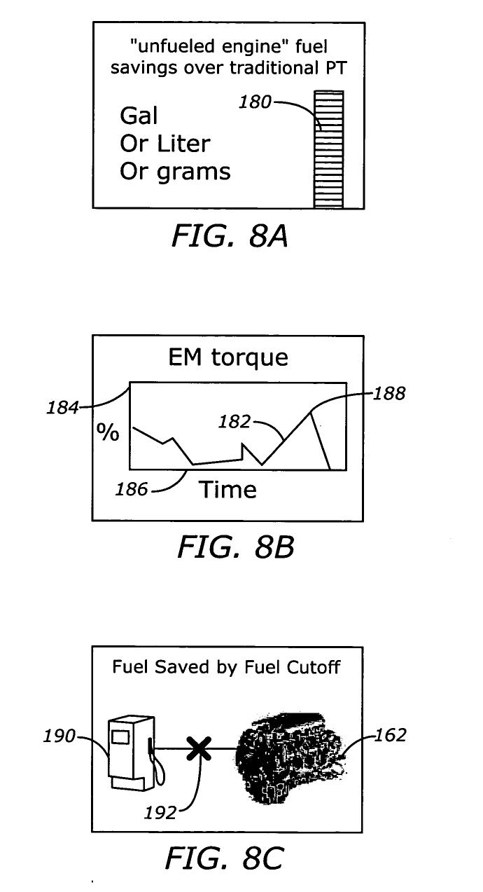

Such detailed data includes bar graph 180 of FIG. 8A that indicates the amount of fuel saved. Also, the data includes line graph 182 of FIG. 8B that indicates EM torque percent (%) measured by ordinate axis 184 as a function of a rolling time scale indicated by abscissa 186. An interested driver can correlate the increases and decreases of the magnitude of graph 182 with events either felt or not felt while driving the hybrid vehicle. For instance, point 188 could represent that the EM is working with to the IC engine to provide increased performance. A graph such as 182 could also be used to represent the displacement on demand operation of an IC engine. FIG. 8C indicates that fuel 190 is being saved 192 because of fuel cutoff due to either IEO or DFCO.

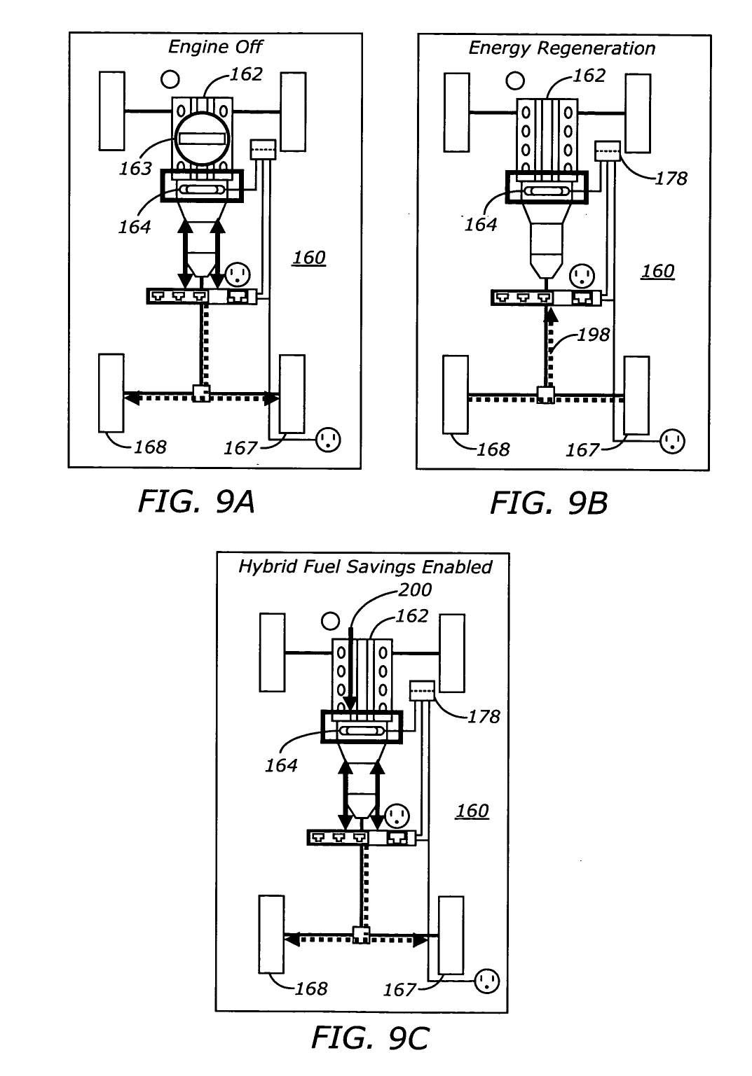

The following Storyboard 4 occurs in response to the user selecting “Real Time Mode Display” from the menu 138 of FIG. 6C. Storyboard 4 and FIGS. 9A, 9B and 9C relate to various modes of operation of the parallel hybrid vehicle 160.

### Storyboard 4

| Column 1 | Column 2 | Column 3 |
|---|---|---|
| Screen Concepts | Hybrid Powertrain | Expected Action |
| shown by: | State | |
| | IC Engine Off | Display message |
| | | “Engine Off” |
| | Regeneration through | Display message |
| | Electric Machine | “Energy Regeneration” |
| | Torque Smoothing | Display message |
| | | “Hybrid Fuel Saving Enabled” |

In the case of Storyboard 4, steps 114, 116 or 117 and 118 of method 100 of FIG. 5 are effectuated in response to signals from HCM 40. FIG. 9A shows the IC Engine Off graphic 163 on engine 162. FIG. 9B shows the Energy Regeneration mode wherein the drive wheels 166 and 168 turn EM 164 as indicated by dotted arrow 198 that operates as a generator to recharge battery 178. Arrow 200 of FIG. 9C indicates that IC engine 162 and EM 164 are operating together to provide power to drive wheels 167 and 168 to effectuate the Hybrid Fuel Savings Enabled mode.

PDA 10 can be configured to log data related to PHV 160 on an ongoing basis. Also, PDA 10 can sense if there has been a malfunction signal sent from any of the vehicle controllers and PDA 10 can link back in time and save logged data. This logged data can be downloaded to a personal computer and emailed to technical support to help diagnose malfunctions. Also, the above-described concepts can be extended to other applications of new technologies such as displacement on demand, variable valve timing and continuously variable transmission. In these cases, signals can are also obtained from any or all of respective vehicle control modules ECM 34, TCM 36 and/or BCM 38 and interface 32 is utilized to control other displays programmed into PDA 10.

Thus an inexpensive method 100 and an apparatus 30 has been described for providing a GUI for displaying selected information from existing motorized vehicle control modules of FIG. 3 in a new and meaningful way. The disclosed GUI is suitable for providing a teaching tool for vehicle sales people, operators and customers. Furthermore, the apparatus 30 and method 100 facilitate logging of diagnostic data related to new technologies so that such data can be provided to original equipment manufacturers. Moreover, the method 100 and apparatus 30 requires either no or only minimal changes in the other portions of the overall vehicle system such as either wiring changes or the redesign of the vehicle. This is because circuit 32 of apparatus 30 is located in a plug which mates with the vehicle diagnostic port 44. In addition customers who prefer that technology be transparent can easily remove the PDA 10, cable 48 and interface 32 from a vehicle. Furthermore method 100 and apparatus 30 utilize COTS such as PDA 10 that can be reprogrammed as the need arises. Such uses of COTS decrease costs and provide flexibility.

While at least one exemplary embodiment has been presented in the foregoing detailed description, it should be appreciated that a vast number of variations exist. It should also be appreciated that these exemplary embodiments are only examples, and are not intended to limit the scope, applicability, or configuration of the invention in any way. Rather, the foregoing detailed description provides those skilled in the art with a convenient road map for implementing an exemplary embodiment of the invention. It being understood that various changes may be made in the function and arrangement of elements described in any exemplary embodiment without departing from the spirit and scope of the invention as set forth in the appended claims and the legal equivalents thereof.

1. An apparatus for displaying operational information of an automobile on a signal processing device within an interior cabin of the automobile, comprising:
a first automobile control module configured to generate a first output signal corresponding to the operational information of the automobile;
an interface circuit configured to couple the signal processing unit and said first automobile control module, said interface circuit having a signal translating circuit that is configured to convert said first output signal for use by said signal processing device in displaying the operational information of the automobile; and
a holder associated with said interface circuit and configured to removably attach the signal processing device to the interior cabin space of the automobile.

2. The apparatus of claim 1, wherein said signal processing device is a Personal Digital Assistant (PDA).

3. The apparatus of claim 2, wherein said signal translating circuit converts said first output signal into a serial digital signal for use by said signal processing device in displaying the operational information of the automobile.

4. The apparatus of claim 1, further comprising a second automobile control module coupled to said interface circuit and configured to generate a second output signal corresponding to the operational information of the automobile, which is converted by said signal translating circuit for use by said signal processing device in displaying the operational information of the automobile.

5. The apparatus of claim 1, wherein said first automobile control module is an engine control module.

6. The apparatus of claim 1, wherein said first automobile control module is a transmission control module.

7. The apparatus of claim 1, wherein said automobile is a hybrid automobile.

8. The apparatus of claim 7, wherein the operational information of the automobile is energy regeneration by the hybrid automobile.

9. The apparatus of claim 7, wherein the operational information of the automobile is fuel saving of the hybrid vehicle.

10. A method for displaying operational information of an automobile on a signal processing device within an interior cabin of the automobile, comprising the steps of:
receiving a plurality of output signals corresponding to the operational information of the automobile;
modifying said plurality of output signals to provide a plurality of modified output signals for use by said signal processing device in displaying the operational information of the automobile;
selecting at least one of said plurality of modified output signals; and
displaying said operational information of the automobile corresponding to said at least one of said plurality of modified output signals on the signal processing device within the interior cabin of the automobile.

11. The method of claim 10, wherein said step of selecting at least one of said plurality of modified signals is accomplished without human interaction.

12. The method of claim 10, wherein said step of selecting at least one of said plurality of modified signals is accomplished with human interaction.

13. The method of claim 10, wherein at least part of the operational information of the automobile is a system mode change.

14. The method of claim 10, wherein said signal processing device is a Personal Digital Assistant (PDA).

15. The method of claim 10, wherein said modifying said plurality of output signals comprises converting said plurality of output signals into a serial digital signal for use by said signal processing device in displaying the operational information of the automobile.

16. The method of claim 10, wherein said operational information of the automobile is engine control information.

17. The method of claim 10, wherein said operational information of the automobile is transmission control information.

18. The method of claim 10, wherein said automobile is a hybrid automobile.

19. The method of claim 18, wherein the operational information of the automobile is energy regeneration by the hybrid automobile.

20. The method of claim 18, wherein the operational information of the automobile is fuel saving of the hybrid vehicle.
